(19) United States
(12) Patent Application Publication
(10) Pub. No.: US 2026/0307762 A1
(43) Pub. Date: Oct. 8, 2026

(54) SHIP BOIL-OFF GAS RELIQUEFACTION SYSTEM

(71) Applicant: HANWHA OCEAN CO., LTD, Geoje-Si, Gyeongsangnam-do (KR)

(72) Inventors: Hyong Woo KIM, Seoul (KR); Hyong Sik LEE, Geoje-si, Gyeongsangnam-do (KR)

(21) Appl. No.: 19/100,767

(22) PCT Filed: Dec. 29, 2022
(86) PCT No.: PCT/KR2022/021569

§ 371 Date: Feb. 3, 2025

(30) Foreign Application Priority Data
Oct. 18, 2022 (KR) 10-2022-0133901

(51) Int. Cl. B63B 25/14; B63B 79/10; B63B 79/40; F17C 5/04

(52) U.S. Cl. CPC B63B 25/14; B63B 79/10; B63B 79/40; F17C 5/04; F17C 2205/0326; F17C 2221/035; F17C 2227/0157; F17C 2227/0341; F17C 2250/0417; F17C 2250/0439; F17C 2265/034; F17C 2270/0105

(57) ABSTRACT

A ship boil-off gas reliquefaction system includes: a compression part comprising a first compressor receiving and compressing boil-off gas generated from liquefied gas in a cargo tank provided to a ship and a second compressor further compressing the boil-off gas compressed in the first compressor, and performing multistage compression of the boil-off gas; an intercooler supplying the boil-off gas compressed in the first compressor to the second compressor after cooling the compressed boil-off gas received from the first compressor; a condenser cooling the boil-off gas compressed through the compression part; a reliquefied gas recovery line delivering liquefied gas cooled and condensed in the condenser to the cargo tank after recovery of cold heat from the liquefied gas through the intercooler; and a first temperature regulation line branching the liquefied gas from the reliquefied gas recovery line and spraying the liquefied gas onto the top of the intercooler.

### TECHNICAL FIELD

The present invention relates to a boil-off gas reliquefaction system for ships and, more particularly, to a boil-off gas reliquefaction system for ships that recovers boil-off gas generated from liquefied gas in a cargo tank through compression and reliquefaction of the boil-off gas.

### BACKGROUND ART

Consumption of liquefied gases, such as liquefied natural gas (LNG) and liquefied petroleum gas (LPG), is rapidly growing around the world. Liquefied gases are transported in a gaseous state through onshore or offshore gas pipelines, or transported in a liquid state to distant destinations by liquefied gas carriers. Liquefied gases, such as LNG and LPG, are obtained by cooling natural gas or petroleum gas to cryogenic temperatures (about −163 °C for LNG) and are suited to long-distance transportation by sea since the volume thereof is significantly reduced compared to that of natural gas in a gaseous state.

Conventional LPG carriers employ a fuel supply system that uses heavy fuel oil, such as bunker C oil, which is relatively inexpensive, as fuel for propulsion engines. Such a heavy fuel oil supply system requires a separate low sulfur heavy fuel oil (LSHFO) tank due to strict enforcement of international emission regulations on the use of heavy fuel oil, which has led to great demand for eco-friendly fuel supply systems that satisfy international environmental standards.

In recent years, more and more LPG or LNG carriers adopt a fuel supply system using LPG, LNG, or boil-off gas generated therefrom as fuel for propulsion, and, corresponding to strict enforcement of international emission regulations, the use of LNG or LPG as fuel for propulsion is also increasing among ships other than LPG or LNG carriers.

In particular, LPG is easier to store than LNG, which is liquefied at cryogenic temperatures, and has good properties in terms of reduction of SO_{X}, NO_{X}, CO₂, and PM emissions compared to conventional HFO without being inferior to HFO in terms of specific energy and energy density.

### DISCLOSURE

### Technical Tasks

Petroleum gas has a low liquefaction temperature of about −42 °C under normal pressure and can be stored in a liquid state up to a temperature of about 45 °C at 18 bar and 20 °C at 7 bar. Since LPG has a boiling point of −42 °C, an LPG storage tank of a ship is insulated. However, due to continuous transfer of external heat to the LPG storage tank, LNG stored in the LNG storage tank continues to evaporate during transportation, causing generation of boil-off gas (BOG).

Accumulation of boil-off gas in the LPG storage tank can cause excessive increase in internal pressure of the storage tank, which poses a threat to safety of the ship and crew. Accordingly, the LPG storage tank has a pressure-resistant structure and a boil-off gas reliquefaction system is used to treat boil-off gas generated in the storage tank.

The present invention proposes a reliquefaction system that can reliquefy boil-off gas generated from liquefied gas, such as LPG, and can return the reliquefied boil-off gas to the storage tank to regulate a tank pressure while reducing the number of essential facilities, thereby reducing costs and increasing price competitiveness of the ship.

### Technical Solution

In accordance with one aspect of the present invention, there is provided a boil-off gas reliquefaction system for ships, including: a compression part including a first compressor receiving and compressing boil-off gas generated from liquefied gas in a cargo tank provided to a ship and a second compressor further compressing the boil-off gas compressed in the first compressor, and performing multistage compression of the boil-off gas;
an intercooler supplying the boil-off gas compressed in the first compressor to the second compressor after cooling the compressed boil-off gas received from the first compressor;
a condenser cooling the boil-off gas compressed through the compression part;
a reliquefied gas recovery line delivering liquefied gas cooled and condensed in the condenser to the cargo tank after recovery of cold heat from the liquefied gas through the intercooler; and
a first temperature regulation line branching the liquefied gas from the reliquefied gas recovery line and spraying the liquefied gas onto the top of the intercooler.

Preferably, the boil-off gas reliquefaction system further includes: a first temperature sensor sensing a temperature of the boil-off gas to be delivered to the second compressor after being cooled in the intercooler; and a first temperature regulation valve regulating a flow rate of the liquefied gas to be branched into the first temperature regulation line, wherein the first temperature regulation valve is controlled according to the temperature of the boil-off gas sensed by the first temperature sensor to regulate the temperature of the boil-off gas delivered to the second compressor.

Preferably, the boil-off gas reliquefaction system further includes: a liquid level regulation line branched from the reliquefied gas recovery line and delivering the liquefied gas into the intercooler; a liquid level sensor sensing a liquid level of the liquefied gas inside the intercooler; and a liquid level regulation valve opening or closing the liquid level regulation line, wherein the liquid level regulating valve is controlled according to the liquid level of the liquefied gas sensed by the liquid level sensor to maintain the liquid level of the liquefied gas inside the intercooler in a certain range and the boil-off gas compressed in the first compressor is supplied into the liquefied gas in the intercooler through a spray nozzle to be cooled by the liquefied gas.

Preferably, the boil-off gas reliquefaction system further includes: a knockout drum receiving the boil-off gas discharged from the cargo tank to supply the boil-off gas to the first compressor of the compression part; and a second temperature regulation line branched from the reliquefied gas recovery line downstream of the intercooler and connected to the knockout drum, wherein the liquefied gas in the reliquefied gas recovery line is delivered to a lower side of the knockout drum to cool the boil-off gas to be delivered to the compression part.

Preferably, the boil-off gas reliquefaction system further includes: a second temperature sensor sensing a temperature of the boil-off gas compressed in the first compressor and introduced into the intercooler; and a second temperature regulation valve regulating a flow rate of the liquefied gas to be branched into the second temperature regulation line, wherein the second temperature regulation valve is controlled according to the temperature of the boil-off gas sensed by the second temperature sensor to regulate the flow rate of the liquefied gas to be delivered to the lower side of the knockout drum.

Preferably, the boil-off gas reliquefaction system further includes: a reliquefied gas receiver disposed upstream of the intercooler in the reliquefied gas recovery line to receive the reliquefied gas cooled in the condenser, wherein a gas is separated in the reliquefied gas receiver to be discharged to a vent line.

Preferably, the liquefied gas includes liquefied petroleum gas (LPG) and the compression part is a three-stage centrifugal compressor or a three-stage reciprocating compressor.

### Advantageous Effects

In a boil-off gas reliquefaction system according to the present invention, when reliquefied gas is returned to a cargo tank after reliquefaction of boil-off gas generated from liquefied gas stored in a cargo tank through cooling and compression of the boil-off gas, the reliquefaction rate of the boil-off gas can be increased by maximizing a cooling effect of an intercooler while reducing power consumption of a compression part in consideration of multicomponent boil-off gas allowing large variation in physical properties.

Furthermore, the boil-off gas reliquefaction system according to the present invention enables reduction in the number of essential facilities in a ship, thus reducing installation costs while increasing price competitiveness of the ship, and allows boil-off gas to be returned to the cargo tank through reliquefaction, thereby improving an LPG transportation rate while maintaining an internal pressure of the cargo tank.

### DESCRIPTION OF DRAWINGS

FIG. 1 is a schematic diagram illustrating one example of a system for reliquefying boil-off gas generated from LPG.

FIG. 2 is a schematic diagram of a boil-off gas reliquefaction system for ships according to one embodiment of the present invention.

FIG. 3 is a schematic diagram of a boil-off gas reliquefaction system for ships according to another embodiment of the present invention.

### EMBODIMENTS

In order to fully appreciate the operational advantages of the present invention and the objectives achieved by practicing the present invention, reference should be made to the accompanying drawings, which illustrate embodiments of the present invention, and description thereof.

Hereinafter, example embodiments of the present invention will be described in detail in terms of the features and effects thereof with reference to the accompanying drawings. It should be noted that like components will be denoted by like reference numerals throughout the specification and the accompanying drawings.

In the embodiments of the present invention described herein, the term “ship” may refer to any type of ship. For example, the ship may include self-propelled vessels, such as an LPG carrier, a very large gas carrier (VLGC), an LNG carrier, a liquid hydrogen carrier, and an LNG regasification vessel (RV), as well as non-self-propelled floating offshore structures, such as an LNG floating production storage and offloading (FPSO) unit and an LNG floating storage regasification unit (FSRU).

In addition, the embodiments of the present invention may be applied to a reliquefaction system for any type of liquefied gas that can be transported in a liquid state by liquefaction at cryogenic temperatures and can generate boil-off gas during storage. For example, such liquefied gas may include liquefied petrochemical gas, such as liquefied natural gas (LNG), liquefied ethane gas (LEG), liquefied petroleum gas (LPG), liquefied ethylene gas, and liquefied propylene gas, and ammonia. The following description of the embodiments of the present invention will focus on application of LPG as liquefied gas by way of example.

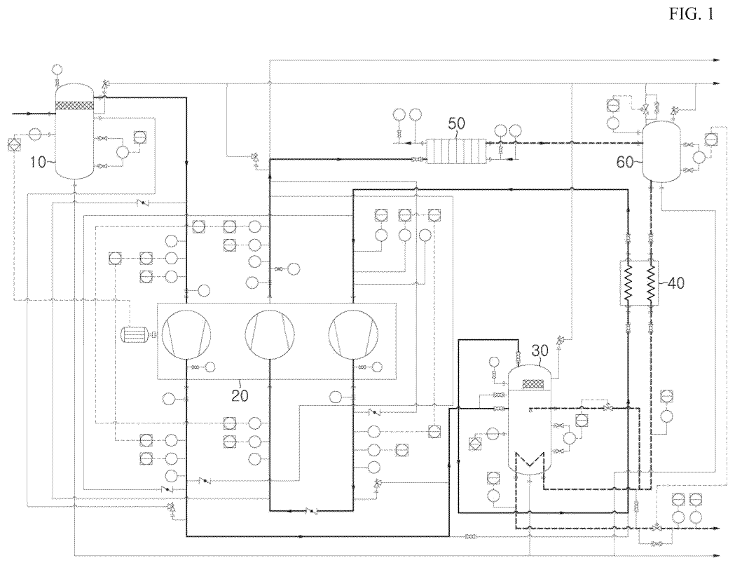

FIG. 1 is a schematic diagram illustrating one example of a system for reliquefying boil-off gas generated from LPG.

Referring to FIG. 1, boil-off gas generated in a cargo tank T is delivered to a compressor 20 through a knockout drum 10 to be compressed, is cooled and reliquefied in a condenser 30, and is returned to the cargo tank via a reliquefied gas container 40, an intercooler 50, and the like.

To compress boil-off gas to a pressure for reliquefaction, the compressor 20 may include a multi-stage compressor, for example, a three-stage compressor and is typically operated at a constant rate. To improve operational efficiency of the compressor, boil-off gas compressed in a first stage compressor is cooled through an intercooler, which may utilize cold heat of reliquefied LPG, before being introduced into a second stage compressor.

However, boil-off gas generated from LPG in a cargo tank contains various components, such as ethane, propylene, and the like in addition to propane and butane (I-Butane/N-Butane), and allows large variation in physical properties.

In order to improve compressor efficiency and reliquefaction efficiency by effectively cooling multicomponent boil-off gases allowing large variation in physical properties, a trim cooler 40 is provided to the system to perform additional cooling of boil-off gas to be introduced into the second stage compressor after being cooled in the intercooler and a separate intercooler may be further installed between the second stage compressor and a third stage compressor.

However, due to the characteristics of the compressor operating at a constant rate and large variation in amount of the multicomponent boil-off gas, it is difficult to effectively control the temperature of the boil-off gas introduced into the second stage compressor through the intercooler and the trim cooler, and when the boil-off gas is introduced into the compressor without being sufficiently cooled, there are problems of increase in power consumption of the compressor and decrease in final liquefaction efficiency. As a result, complete reliquefaction of the boil-off gas is difficult in practice and non-liquefied gas is processed through a separate vent gas system. The reliquefaction system according to embodiments of the present invention is designed to solve these problems, thereby achieving reduction in power consumption of the compressor and in equipment costs while increasing reliquefaction efficiency by effectively cooling the multicomponent boil-off gas allowing large variation in physical properties.

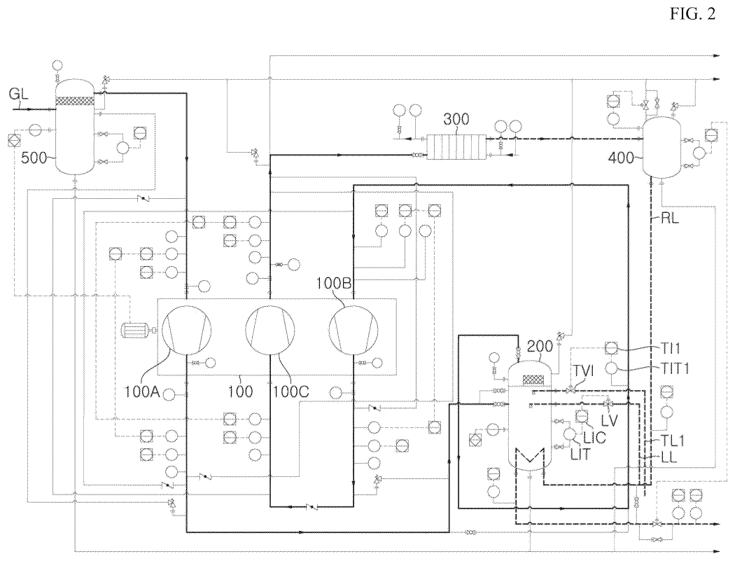

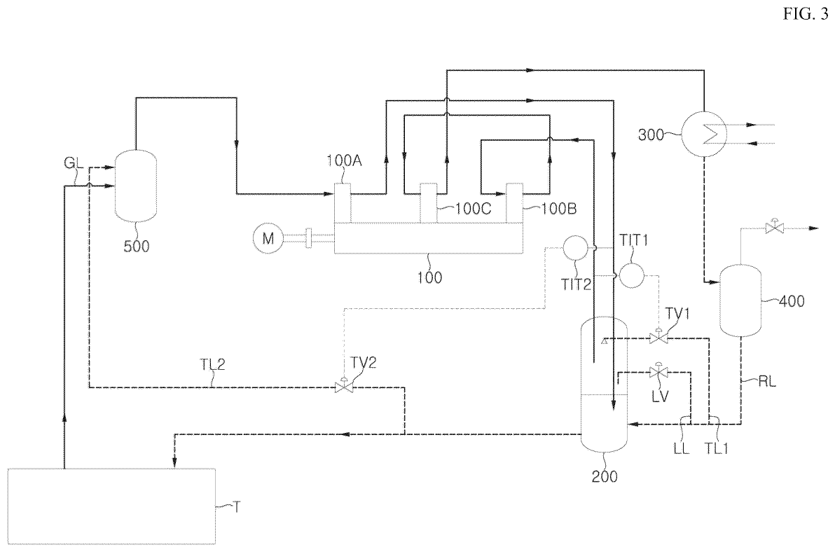

FIG. 2 is a schematic diagram of a boil-off gas reliquefaction system for ships according to one embodiment of the present invention and FIG. 3 is a schematic diagram of a boil-off gas reliquefaction system for ships according to another embodiment of the present invention.

Referring to FIG. 2, the boil-off gas reliquefaction system according to this embodiment includes: a compression part 100, which performs multistage compression of boil-off gas and includes: a first compressor 100A receiving and compressing boil-off gas generated from liquefied gas in a cargo tank on a ship and a second compressor 100B additionally compressing the boil-off gas compressed in the first compressor; an intercooler 200 that receives the compressed boil-off gas from the first compressor and supplies the compressed boil-off gas to the second compressor after cooling the compressed boil-off gas; a condenser 300 that cools the boil-off gas compressed through the compression part; a liquefied gas recovery line RL that delivers the reliquefied boil-off gas cooled and condensed in the condenser to the cargo tank after recovery of cold heat from the reliquefied boil-off gas through the intercooler, and a first temperature regulation line TL1 that branches the liquefied gas from the liquefied gas recovery line and sprays the liquefied gas onto the top of the intercooler.

The boil-off gas reliquefaction system includes: a knockout drum 500 provided to the gas reliquefaction line GL upstream of the compression part and receiving boil-off gas discharged from the cargo tank to supply the gas to the compression part 100. Boil-off gas generated in the cargo tank may include various components, such as ethane, propylene, ammonia, and the like in addition to propane and butane (isobutane/n-butane). Multicomponent boil-off gas generated in the cargo tank is discharged to the knockout drum 500 along the gas reliquefaction line GL and the gas separated in the knockout drum is delivered to the first compressor of the compression part 100 to be subjected to a reliquefaction process and is finally returned to the cargo tank T.

The compression part 100 may be a three-stage compressor including a first compressor 100A that receives and compresses the boil-off gas, a second compressor 100B that further compresses the boil-off gas compressed in the first compressor, and a third compressor 100C that further compresses the boil-off gas compressed in the second compressor and delivers the compressed boil-off gas to a condenser. The compression part may be composed of a three-stage centrifugal compressor including the first to third compressors, or may be composed of a three-stage reciprocating compressor with reciprocating pistons, as in an embodiment shown in FIG. 3. Additional compression stages may be added, as needed.

The boil-off gas compressed through the compression part is supplied to the condenser 300, in which the boil-off gas is cooled.

In the condenser 300, the boil-off gas compressed through the compression part 100 is cooled to reliquefy the boil-off gas through heat exchange and a heat source for cooling the boil-off gas may include, for example, seawater easily available from a ship.

The reliquefied gas cooled in the condenser 300 is received by a reliquefied gas receiver 400 along the reliquefied gas recovery line, the liquid in the reliquefied gas receiver is returned to the cargo tank along the reliquefied gas recovery line RL, and a vent gas separated in the reliquefied gas receiver is discharged through a vent line.

The reliquefied gas recovery line RL is connected to the cargo tank through the intercooler 200. In the intercooler 200, the boil-off gas compressed in the first compressor 100A is subjected to heat exchange with the reliquefied gas to be delivered to the cargo tank. As shown in FIG. 2, the boil-off gas compressed in the first compressor 100A of the compression part is sequentially delivered to the intercooler 200 to be subjected to intermediate cooling by the reliquefied gas delivered from the reliquefied gas receiver 400 to the cargo tank, to the second compressor 100B to be compressed in the second compressor 100B, to the third compressor 100C to be further compressed in the third compressor 100C, and to the condenser 300 to be cooled and reliquefied.

The boil-off gas reliquefaction system is further provided with a liquid level regulation line LL branched from the reliquefied gas recovery line RL to deliver the liquefied gas to the intercooler 200, a liquid level sensor LIC to sense the level of the liquefied gas inside the intercooler, and a liquid level regulation valve LV to open or close the liquid level regulation line. According to the liquid level sensed by the liquid level sensor, a liquid level controller LIC controls the liquid level regulation valve to maintain the level of the liquefied gas inside the intercooler in a certain range.

The boil-off gas compressed in the first compressor 100A may be supplied into the liquefied gas in the intercooler 200 through a spray nozzle. The liquefied gas passing through the liquefied gas recovery line via the liquefied gas receiver may also supply cold heat into the intercooler while passing through a heat conduction tube disposed below the intercooler and filled with the liquefied gas, and the boil-off gas compressed in the first compressor is cooled in the intercooler.

Furthermore, in this embodiment, in consideration of multi-component boil-off gas allowing large variation in physical properties, the boil-off gas reliquefaction system is further provided with features for maximizing the cooling effects and fine regulation of the temperature of the boil-off gas to be delivered to the second compressor so as to reduce compression power consumption while increasing the reliquefaction rate.

To this end, the boil-off gas reliquefaction system according to this embodiment includes a first temperature regulation line TL1 that branches the liquefied gas from the reflux line RL and sprays the liquefied gas onto the top of the intercooler 200, a first temperature sensor TIT1 that detects the temperature of the boil-off gas cooled in the intercooler to be delivered to the second compressor, and a first temperature regulation valve TV1 that regulates the flow rate of the liquefied gas to be branched to the first temperature regulation line.

According to the temperature of the boil-off gas downstream of the intercooler sensed by the first temperature sensor TIT1, the first temperature controller TI1 controls the first temperature regulation valve TV1 such that a portion of the liquefied gas in the reliquefied gas recovery line is branched into the first temperature regulation line to be sprayed onto the top of the intercooler such that the boil-off gas cooled at a lower side of the intercooler can be further cooled to adjust the temperature of the boil-off introduced into the second compressor. The first temperature regulation line may be provided at a distal end thereof with a spray nozzle for additional cooling to spray the liquefied gas.

In this way, as the intercooler improves cooling efficiency of the boil-off gas to be introduced into the second compressor after compression in the first compressor of the compression part while allowing fine regulation of the temperature of the boil-off gas upstream of the second compressor, it is possible to reduce equipment costs and power consumption of the compression part while improving reliquefaction efficiency even without a separate intermediate cooling device between the second compressor and the third compressor.

Furthermore, the boil-off gas is reliquefied and returned to the cargo tank through the boil-off gas reliquefaction system according to this embodiment, thereby increasing the LPG transportation rate while safely maintaining the temperature in the cargo tank.

A boil-off gas reliquefaction system according to another embodiment shown in FIG. 3 is configured to increase the reliquefaction rate while further reducing power consumption of the compression part by additionally lowering the temperature of the boil-off gas to be delivered from the knockout drum to the first compressor of the compression part.

To this end, referring to FIG. 3, the boil-off gas reliquefaction system according to this embodiment may further include a second temperature regulation line TL2 branched from the reliquefied gas recovery line RL downstream of the intercooler 200 and connected to the knockout drum to cool the boil-off gas to be delivered to the compression part 100 by spraying a portion of the liquefied gas in the reliquefied gas recovery line into the knockout drum 500.

The boil-off gas reliquefaction system according to this embodiment further includes a second temperature sensor TIT2 that detects the temperature of the boil-off gas compressed by the first compressor and introduced into the intercooler, and a second temperature regulation valve TV2 that regulates the flow rate of the liquefied gas to be branched into the second temperature regulation line. The liquefied gas returned to the cargo tank through the reliquefied gas recovery line may be in a sub-cooled state. By controlling the second temperature regulation valve according to the temperature of the boil-off gas downstream of the first compressor sensed by the second temperature sensor such that a portion of the liquefied gas in a sub-cooled state downstream of the reliquefied gas recovery line can be branched into the second temperature regulation line and delivered to a lower side of the knockout drum to cool the boil-off gas, the temperature of the boil-off gas introduced into the first compressor of the compression part can be regulated.

Repeated description of the same features as the system according to the above embodiment is omitted.

In this way, a portion of cold liquefied gas downstream of the reliquefied gas recovery line is branched into the second temperature regulation line and delivered to the knockout drum to cool the boil-off gas to be delivered to the compression part, and a portion of the cold liquefied gas is sprayed towards the upper portion of the intercooler through the first temperature regulation line to allow fine regulation of the temperature of the boil-off gas delivered to the second compressor, thereby reducing power consumption of the compression part while increasing a final reliquefaction rate.

Although some embodiments have been described herein, it will be apparent to a person having ordinary knowledge in the art that the present invention is not limited thereto and may be implemented through various modifications or variations without departing from the technical spirit of the present invention.

1. A boil-off gas reliquefaction system for ships, comprising:
a compression part comprising a first compressor receiving and compressing boil-off gas generated from liquefied gas in a cargo tank provided to a ship and a second compressor further compressing the boil-off gas compressed in the first compressor, and performing multistage compression of the boil-off gas;
an intercooler supplying the boil-off gas compressed in the first compressor to the second compressor after cooling the compressed boil-off gas received from the first compressor;
a condenser cooling the boil-off gas compressed through the compression part;
a reliquefied gas recovery line delivering liquefied gas cooled and condensed in the condenser to the cargo tank after recovery of cold heat from the liquefied gas through the intercooler; and
a first temperature regulation line branching the liquefied gas from the reliquefied gas recovery line and spraying the liquefied gas onto the top of the intercooler.

2. The boil-off gas reliquefaction system according to claim 1, further comprising:
a first temperature sensor sensing a temperature of the boil-off gas to be delivered to the second compressor after being cooled in the intercooler; and
a first temperature regulation valve regulating a flow rate of the liquefied gas to be branched into the first temperature regulation line,
wherein the first temperature regulation valve is controlled according to the temperature of the boil-off gas sensed by the first temperature sensor to regulate the temperature of the boil-off gas delivered to the second compressor.

3. The boil-off gas reliquefaction system according to claim 2, further comprising:
a liquid level regulation line branched from the reliquefied gas recovery line and delivering the liquefied gas into the intercooler;
a liquid level sensor sensing a liquid level of the liquefied gas inside the intercooler; and
a liquid level regulation valve opening or closing the liquid level regulation line,
wherein the liquid level regulating valve is controlled according to the liquid level of the liquefied gas sensed by the liquid level sensor to maintain the liquid level of the liquefied gas inside the intercooler in a certain range, and
the boil-off gas compressed in the first compressor is supplied into the liquefied gas in the intercooler through a spray nozzle to be cooled by the liquefied gas.

4. The boil-off gas reliquefaction system according to claim 2, further comprising:
a knockout drum receiving the boil-off gas discharged from the cargo tank to supply the boil-off gas to the first compressor of the compression part; and
a second temperature regulation line branched from the reliquefied gas recovery line downstream of the intercooler and connected to the knockout drum,
wherein the liquefied gas in the reliquefied gas recovery line is delivered to a lower side of the knockout drum to cool the boil-off gas to be delivered to the compression part.

5. The boil-off gas reliquefaction system according to claim 4, further comprising:
a second temperature sensor sensing a temperature of the boil-off gas compressed in the first compressor and introduced into the intercooler; and
a second temperature regulation valve regulating a flow rate of the liquefied gas to be branched into the second temperature regulation line,
wherein the second temperature regulation valve is controlled according to the temperature of the boil-off gas sensed by the second temperature sensor to regulate the flow rate of the liquefied gas to be delivered to the lower side of the knockout drum.

6. The boil-off gas reliquefaction system according to claim 1, further comprising:
a reliquefied gas receiver disposed upstream of the intercooler in the reliquefied gas recovery line to receive the reliquefied gas cooled in the condenser,
wherein a gas is separated in the reliquefied gas receiver to be discharged to a vent line.

7. The boil-off gas reliquefaction system according to claim 6, wherein the liquefied gas comprises liquefied petroleum gas (LPG) and the compression part is a three-stage centrifugal compressor or a three-stage reciprocating compressor.
